(19) United States
(12) Patent Application Publication
(10) Pub. No.: US 2026/0102969 A1
(43) Pub. Date: Apr. 16, 2026

(54) 3D PRINTER WITH SUPPORTED UMBILICAL TO PRINT HEAD

(71) Applicant: Stratasys, Inc., Minnetonka, MN (US)

(72) Inventors: James Paul Flannigan, Mendota Heights, MN (US); Colin Schiel, Chaska, MN (US); Ross Michalkiewicz, Minneapolis, MN (US); Kyra Elizabeth Neal, Crystal, MN (US); Bryan Daniel Migliori, Lakeville, MN (US); Austin John Schlichting, Elk River, MN (US)

(21) Appl. No.: 19/132,123

(22) PCT Filed: Jan. 18, 2024
(86) PCT No.: PCT/US2024/011941

§ 371 Date: May 22, 2025

Related U.S. Application Data
(60) Provisional application No. 63/480,707, filed on Jan. 20, 2023.

(51) Int. Cl. B29C 64/209; B29C 64/118; B29C 64/232; B29C 64/25; B33Y 30/00

(52) U.S. Cl. CPC B29C 64/209; B29C 64/118; B29C 64/232; B29C 64/25; B33Y 30/00

(57) ABSTRACT

An extrusion-based 3D printer configured to print parts in a layer-wise manner includes a build chamber and an unheated region above the build chamber. A print head is located in the unheated region and moves in an x-y plane across the build chamber and is lifted and lowered in a z dimension where a nozzle of the print head is configured to extend into the build chamber when the print head is lowered. The printer includes an umbilical within the unheated region configured to support a plurality of operational feeds, the umbilical having a length between a first end and a second end that is configured to be coupled to the print head. The umbilical includes a backbone running the length of the umbilical configured to provide support and flexibility to the plurality of operational feeds and a plurality of fixtures spaced along a length of the umbilical.

### BACKGROUND

The present disclosure relates to additive manufacturing systems for 3D printing of parts by material extrusion techniques. In particular, the present disclosure relates to a 3D printer with a supported umbilical to supply filament, to provide heating and cooling sources, to provide power and to send control signals to a print head. All references disclosed herein are incorporated by reference.

Additive manufacturing, also called 3D printing, is generally a process in which a three-dimensional (3D) part is built by adding material to form a 3D part rather than subtracting material as in traditional machining. Using one or more additive manufacturing techniques, a three-dimensional solid part of virtually any shape can be printed from a digital model of the part by an additive manufacturing system, commonly referred to as a 3D printer. A typical additive manufacturing work flow includes slicing a three-dimensional computer model into thin cross sections defining a series of layers, translating the result into two-dimensional position data, and transmitting the data to a 3D printer which manufactures a three-dimensional structure in an additive build style. Additive manufacturing entails many different approaches to the method of fabrication, including material extrusion, ink jetting, powder bed fusion, binder jetting, direct energy deposition, electrophotographic imaging, and vat photopolymerization (including digital light curing and stereolithographic processes).

In a typical extrusion-based additive manufacturing system (e.g., fused deposition modeling systems developed by Stratasys, Inc., Eden Prairie, MN), a 3D part may be printed from a digital representation of the printed part by extruding a viscous, flowable thermoplastic or filled thermoplastic material from a print head along toolpaths at a controlled extrusion rate. The extruded flow of material is deposited as a sequence of roads onto a substrate, where it fuses to previously deposited material and solidifies upon a drop in temperature. The print head includes a liquefier which receives a supply of the thermoplastic material in the form of a flexible filament, and a nozzle tip for dispensing molten material. A filament drive mechanism engages the filament such as with a drive wheel and a bearing surface, or pair of toothed-wheels, and feeds the filament into the liquefier where the filament is heated to a molten pool. The unmelted portion of the filament essentially fills the diameter of the liquefier tube, providing a plug-flow type pumping action to extrude the molten filament material further downstream in the liquefier, from the tip to print a part, to form a continuous flow or toolpath of resin material. The extrusion rate is unthrottled and is based only on the feed rate of filament into the liquefier, and the filament is advanced at a feed rate calculated to achieve a targeted extrusion rate, such as is disclosed in Comb U.S. Pat. No. 6,547,995.

In a system where the material is deposited in planar layers, the position of the print head relative to the substrate is incremented along an axis (perpendicular to the build plane) after each layer is formed, and the process is then repeated to form a printed part resembling the digital representation. In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited pursuant to the generated geometry during the printing process. The support material adheres to the part material during fabrication and is removable from the completed printed part when the printing process is complete.

A multi-axis additive manufacturing system may be utilized to print 3D parts using fused deposition modeling techniques. The multi-axis system may include a robotic arm movable in multiple degrees of freedom. The multi-axis system may also include a build platform movable in two or more degrees of freedom and independent of the movement of the robotic arm to position the 3D part being built to counteract effects of gravity based upon part geometry. An extruder may be mounted at an end of the robotic arm and may be configured to extrude material with a plurality of flow rates, wherein movement of the robotic arm and the build platform are synchronized with the flow rate of the extruded material to build the 3D part. The multiple axes of motion can utilize complex tool paths for printing 3D parts, including single continuous 3D tool paths for up to an entire part, or multiple 3D tool paths configured to build a single part. Use of 3D tool paths can reduce issues with traditional planar toolpath 3D printing, such as stair-stepping (layer aliasing), seams, the requirement for supports, and the like. Without a requirement to print layers of a 3D part in a single build plane, the geometry of part features may be used to determine the orientation of printing.

As 3D printers become larger and include tool changers where print heads are swapped out during the printing process, there is a need to support the filament feed line tubing, optional heating and cooling sources and optional electrical power supply wires, known as the umbilical, from the filament supply location to the print head or tool, such that the filament feed tube and associated wires of one print head or tool do not interfere with the movement of another tool or print head during the printing process. In some instances, pass through power and communication handoff can be used such that the cables are not necessary. However, in the event that pass through power and communication handoff technology is utilized, there is still a need to support the filament feed line. Additionally, there is a need to support the umbilical such that as the print head or tool moves, the filament is restrained from exceeding the bend radius where the filament can fracture within a filament feed path supply tubing, between the supply and the print head or tool.

### SUMMARY

An aspect of the present disclosure relates to an extrusion-based 3D printer configured to print 3D parts in a layer-wise manner. The 3D printer includes a build chamber and an unheated region above the build chamber. A print head is located in the unheated region and is configured to be moved in an x-y plane across the build chamber and also to be lifted and lowered in a z dimension. The print head has a nozzle configured to extend into the build chamber when the print head is lowered. The printer includes an umbilical within the unheated region configured to support a plurality of operational feeds comprising a filament feed tube and a power cable, the umbilical having a length between a first end and a second end that is configured to be coupled to the print head. The umbilical includes a backbone running the length of the umbilical, the backbone configured to provide support and flexibility to the plurality of operational feeds and a plurality of fixtures spaced along a length of the umbilical, wherein the plurality of fixtures maintain the filament tube, the power cable and the backbone in a spaced apart spatial relationship while providing support from the backbone to the filament tube and the power cable. The umbilical includes a substantially rigid pivot arm secured to the umbilical proximate the first end, the substantially rigid pivot arm being configured to pivot about a pivot axis as the print head and umbilical move.

Another aspect of the present disclosure relates to a 3D printer configured to print 3D parts in a layer-wise manner. The 3D printer includes a build chamber, a build platen within the chamber and an unheated tool chamber above the build chamber. The 3D printer includes a plurality of print heads housed within the tool chamber, each of the plurality of print heads being configured to extrude material onto the build platen or previously extruded material wherein each of the plurality of print heads is configured to be moved in at least an x-y plane across the build chamber and also to be lifted and lowered in a z dimension. The 3D printer includes a plurality of filament supplies and a plurality of umbilicals having a length between a first end and a second end. Each of the plurality of umbilicals is located within the tool chamber and is configured to provide a supported path for a plurality of operational feeds comprising a filament feed tube and a power cable. Each of the plurality of umbilicals includes a backbone running the length of the umbilical, the backbone configured to provide support and flexibility to the plurality of operational feeds and a plurality of fixtures spaced along a length of the umbilical, wherein the plurality of fixtures maintains the filament tube, the power cable and the backbone in a spaced apart spatial relationship while providing support from the backbone to the filament tube and the power cable. Each of the plurality of umbilicals includes a substantially rigid pivot arm secured to the umbilical proximate the first end, the substantially rigid pivot arm being configured to pivot about a pivot axis as the print head and umbilical move.

### BRIEF DESCRIPTION OF THE DRAWINGS

FIG. 1 is a perspective view of an extrusion-based 3D printer of the present invention having a heated build chamber positioned below a tool chamber.

FIG. 2 is a perspective view of portions of the 3D printer shown in FIG. 1, with portions of the frame or cabinet removed to illustrate separation of the build and tool chambers and other features in greater detail.

FIGS. 3-5 are views of the 3D printer shown in FIG. 1, illustrating filament spool cabinets, x-y gantry and local Z positioner features, and an insulator separating the build and tool chambers.

FIG. 6 is a view of left support arms and umbilicals of the 3D printer.

FIG. 7 is a view of an umbilical from the left support arm to a print head.

FIG. 8 is a view of the umbilical attached to the print head.

FIG. 9 is a schematic view of the umbilical in various positions within the tool chamber.

FIG. 10 is partial exploded view of a bracket for securing support members of the umbilical.

FIG. 11 is an exploded view of the bracket.

FIG. 11A is an exploded front view of the bracket.

FIG. 12 is a front view of the bracket.

FIG. 13 is a side view of the bracket.

FIG. 14 is a view of the umbilical members within an insert.

FIG. 15 is a partial cutaway view of the insert within a rigid member configured to attach to the print head.

FIG. 16 is an exploded view of the rigid member and the insert.

FIG. 17 is a side view of the rigid member with a print head attached.

FIG. 18 is a front view of the rigid member with a print head attached.

FIG. 19 is a sectional view of a fixture securing two filament tubes, the power cable, the control cable and the backbone.

FIG. 20 is a schematic view of an alternative print head with a fluid cooling system.

FIG. 21 is a view of a fixture having a cooling fluid line and a return line for a print head configured to print a continuous carbon fiber filament

### DETAILED DESCRIPTION

The present disclosure relates to a 3D printer with supported wires and connectors, known as umbilicals, between filament supplies, control systems, optional heating and cooling systems and print heads or tools. In order to fully function, each print head or tool minimally needs to have wiring and feed material supplies connected to it. When there is more than one print head, or two working in tandem, or up to four print heads, or when the printer volume is a larger format, such as 500 mm×500 mm×500 mm or larger, the movement of the print head around the print volume XYZ space, in conjunction with the multiple umbilical cords becomes difficult to manage. While the present disclosure is in the context of large format FDM printers, the presently disclosed umbilicals can be used with any sized 3D printer In a 3d printer, especially in a large format FDM printer, the print head(s) need to traverse around the entire XY build space of the printing chamber. The umbilicals provide a filament path via tubing, to supply filament from the filament supply cabinets to the print heads, power supply cables to the print heads, and electrical control cables from a controller to the controllable components of the print head, such as the filament drive and the heater. With a large format printer, the length of unsupported filament tubing and wiring or cables connected to each print head is too long to remain unsupported without issue. The use of supports for the tubing, control and power cables and/or optional heating and cooling systems allows each print head to move freely, without being restricted by other cables. The supported tubing maintains a consistent filament supply while the tubing is at a sharp angle, or minimum bend radius, while the print head is moving within the chamber and prevents interference when between the one or more print heads in the print head tool chamber. The use of backbones to hold the wiring and tubing bundles, referred to as umbilicals, and the use of backbones within the umbilicals prevent the umbilicals of print heads on standby from sagging into the path of an active, moving print head while preventing the filament in the filament feed tubing of the active print head from kinking or exceeding the minimum bend radius, which aids in prevention of filament factures. The minimum bend radius of a filament is typically about the smallest diameter coil of the filament on the spool used to supply the filament to the print head, such as around about five inches. The filament can include a majority of a polymer material, such as a thermoplastic material, or can include a majority of a reinforcing material, such as carbon fiber tow material.

The backbones can also be used to manage the number of bends in the guide tube. Managing the number of bends and the bend radius in the guide tube reduces friction between the filament and the guide tube, which results in less force being required to move the filament through the filament path from the supply to the print head. When filament within the feed tubing breaks before it arrives at the print head, it is no longer able to reach the print head.

The backbone within the umbilical is a stiff and yet sufficiently flexible rod which allows the print head to move within the print envelope, while being sufficiently light to prevent excessive drag forces as the print head or tool moves in the build envelope, and yet is stiff enough to support the weight of the tubing, control wires and optional heating and cooling systems. The backbone is also sufficiently resilient to allow the umbilical to flex as the print head moves in the build envelope into far and near corners and after flexing return to a predetermined shape.

The backbone provides the necessary stiffness to the umbilical to prevent sagging as the print head is a longer distance from filament inlet to the guide tube. While being sufficiently stiff to prevent sagging when the print head is a longer distance from the guide tube inlet, the backbone is also sufficiently flexible to allow the print head to be utilized in locations proximate the inlet to the feed tube where the umbilical is close to reaching a fixed point where the filament will no longer flex. The flexible and resilient backbone balances the need for stiffness to prevent sagging while allowing flexibility for the print head to move proximate the inlet to the feed tube without exceeding the minimum bend radius.

By way of example, the bend radius of a particular filament is the nominal radius of the center hub of a spool of filament. The filament can withstand the minimum bend radius when adjacent the hub correlates to the filament being able to withstand the same bend radius when used to print a part. By way of non-limiting example, in the disclosed printer the center hub is about 10 inches in diameter, meaning the minimum bend radius is about 5 inches for a particular filament.

After the print head is returned to a stored position in the tool rack, the backbone within the umbilical returns to a known and repeatable location which maintains a low bend filament path where the umbilical does not interfere with the movement of other print heads. An exemplary, non-limiting material of construction of the backbone constructed of a carbon fiber rod ranging from about 0.075 inch diameter to about 0.125 inch diameter and more typically is a 0.098 inch diameter carbon fiber rod that is about 48 inches in length for the illustrated 3D printer. It is understood that the length and diameter can vary with the size of the 3D printer. An exemplary carbon fiber rod is sold by Rock West Composites, Inc. having a location in San Diego, CA, as carbon fiber is light weight, flexible and resilient while providing sufficient strength to prevent the umbilical from sagging into the path of other moving print heads. However, backbones with different dimeters and materials of construction are within the scope of the present disclosure. The backbone could also be fabricated from spring steel, fiberglass or any other material that substantially returns to a known configuration after being flexed or bent.

In some embodiments, the supported umbilical includes fixtures spaced along the length of the umbilical that retain the individual components within the umbilical, namely, the filament feed tube, the electrical cable, the control cable and the backbone in a substantially fixed and spaced apart spatial relationship relative to each other, to make up the entirety of the umbilical assembly. Retaining the filament feed tube, the electrical cable, the control cable and the backbone in the substantially fixed and spaced apart spatial relationship prevents the lines from rubbing and becoming worn or damaged over time while in due to print head movement throughout the printer chamber.

The supported umbilicals typically include a pivotal connection at each end which allows the active print head to move in the x, y and optionally z direction while reducing drag forces at the connection or pivot points. In some instances, the supported umbilical is retained to a substantially rigid pivoting arm along a portion spaced from the print head, where the substantially rigid pivoting arm provides additional support to the umbilical when used in 3D printers with larger print envelopes. As the print head is removed from the tool rack, and inserted into the heated printer chamber, and moved about the XY space of the printer, the span or reach required by the print head from the corner at which the filament feed tube enters the print head tool chamber to the print location varies greatly, up to several feet in distance. The substantially rigid swiveling pivot arm may not be necessary to aid in supporting the umbilical in smaller format printers, such as those with dimensions under 500 mm×500 mm×500 mm. Rather, the rigid member may provide sufficient support and resiliency to the umbilical cord to avoid kinking or entanglement.

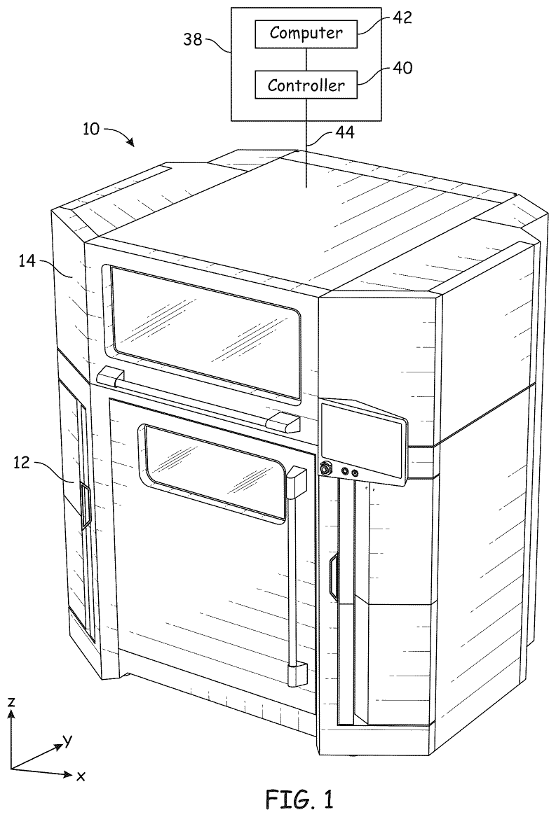

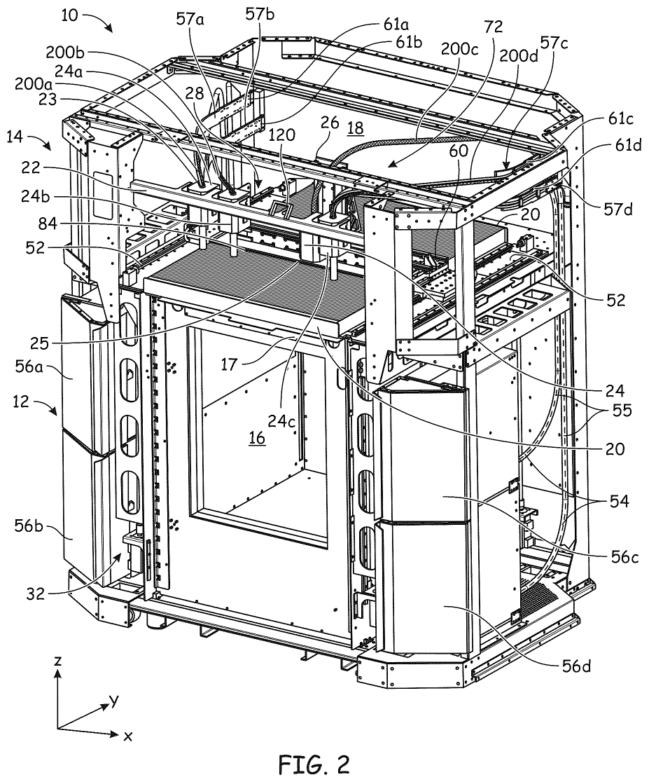

The present disclosure may be used with any suitable additive manufacturing system, commonly referred to as a 3D printer. For example, FIGS. 1-5 illustrate a 3D printer 10 having features as discussed above. FIG. 1 is a perspective view of the 3D printer enclosed in cabinets. FIGS. 2-5 are perspective views, side views or top views of the 3D printer with portions removed to illustrate internal features more clearly. As shown initially in FIGS. 1 and 2, 3D printer 10 includes a build chamber cabinet 12 housing a heated build chamber 16 and a tool chamber cabinet 14 housing a separate tool chamber 18, with the tool chamber positioned on top of the build chamber. The tool chamber 18 houses multiple individually powered tools, in a tool rack 22, including selectable print heads 24. The tool chamber is unheated to protect the electronic elements of the print heads and gantry controls. The heated chamber 16 is separated from the tool chamber 18 by a thermal barrier that spans the range of motion of the print heads 24.

The 3D printer 10 includes a print head carriage 26 which connects or couples to a selected tool or print head, with an x-y gantry 28 moving the carriage 26 and a selected print head in an x-y plane above a build plane such that the nozzle 25 is within the heated build chamber 16. The build plane is provided with a platen or platen assembly 30 (shown in FIGS. 3-5) within the build chamber 16, with the platen 30 being moved in a vertical z direction within the build chamber by a platen gantry 32. The tool chamber 18 and heated build chamber 16 are separated by a thermal insulator 20, which allows the carriage 26 to remain within the (unheated) tool chamber 18 while the nozzle 25 extends through the thermal insulator 20 into the heated build chamber 16, such that thermal isolation can be maintained between the build environment and the tool chamber 18.

In the exemplary embodiment of 3D printer 10, a print head 24 is shown engaged on a tool mount 23 of the carriage and has an inlet 23 for receiving a consumable build material and a nozzle 25 for dispensing the build material onto the platform in a flowable state. The consumable build material is provided to the print head from one or more filament spools 50 positioned within cabinets 56a, 56b, 56c and 56d positioned on a side of the build chamber, and through filament guide tubes 54 extending from the cabinets, to the print head.

Umbilicals 57a, 57b, 57c and 57d include toolpaths from cabinets 56a, 56b, 56c and 56d to the print heads 24a, 24b, 24c and 24d, all respectively. The umbilicals 57a, 57b, 57c and 57d supply power and control as well as the filament, and optional heating and cooling to the respective print heads 24a, 24b, 24c and 24d from the cabinets 56a, 56b, 56c and 56d and a power supply and controller for the printer 10. The umbilicals 57a, 57b, 57c and 57d include resilient internal supports, referred to as backbones, as well as external support arms that allow each print head 24a, 24b, 24c and 24d to move within the print envelope without interference from the other umbilicals 57a, 57b, 57c and 57d of the print heads in standby mode.

The building material is optionally and preferably in a filament form that is suitable for use in an extrusion-based additive manufacturing. The building material may be any extrudable material or material combinations, including amorphous or semi-crystalline thermoplastics, and thermosets, and may include fillers, chopped fibers, and/or a continuous fiber reinforcement. For example, appropriate polymers include, but are not limited to, acrylonitrile butadiene styrene (ABS), nylon, polyetherimide (PEI), polyaryletherketone (PAEK), polyether ether ketone (PEEK), polyactic acid (PLA), Liquid Crystal Polymer, polyamide, polyimide, polysulfone, polytetrafluoroethylene, polyvinylidene, and various other thermoplastics.

A fiber-reinforced filament may consist of one or more types of continuous fibers. The continuous fibers may be extended, woven, or non-woven fibers in random or fixed orientations and may consist of, for example, carbon fibers, glass fibers, fabric fibers, metallic wires, and optical fibers. The fiber-reinforced filament may also consist of short fibers alone or in combination with one or more continuous fibers. Appropriate fibers or strands include those materials which impart a desired property, such as structural, conductive (electrically and/or thermally), insulative (electrically and/or thermally), and/or optical. Further, multiple types of fibers may be used in a single fiber-reinforced filament to provide multiple functionalities such as electrical and optical properties.

As shown, the x-y gantry 28 is mounted on top of the build chamber, and in an exemplary embodiment comprises an x-bridge 60, y-rails 52, and associated x and y motors for moving and positioning the carriage 26 (and any build tool installed on the carriage) in an x-y plane above the build plane. The carriage is supported on the x-bridge and includes a mount 29 for receiving and retaining print heads and a local Z positioner 72 for controllably moving a retained print head out of the x-y build plane along a perpendicular z direction axis (e.g., not in a pivoting manner). The local Z positioner operates to move a retained print head in a limited Z band of motion from a build position to a tool change position. Additionally, in some embodiments may be utilized while the carriage is moving in x-y or when it is in a fixed x-y position. The x-y gantry, as well as the local Z positioner, can utilize any suitable motors, actuators or systems to move the carriage and print head in the x, y and z directions as discussed.

The local Z positioner also operates to move a newly retained print head over the tool chamber and into a calibration chamber 17 separate from the heated chamber 16 and tool chamber 18. The calibration chamber 17 includes the sensor 19 configured to calibrate a location of a nozzle tip surface 25 on the print head 24 in x, y and z. Once the print head is over the calibration chamber 17, the print head is lowered into the calibration chamber 17 proximate the sensor to sense the location of the nozzle tip surface 25.

Tool crib or rack 22 is located above the build chamber at a position reachable by the tool mount 27 when elevated by the local Z positioner 72. The tool mount may engage with and support a print head, and is used to retain and swap print heads provided in the rack. In general, any modular tools, such as print heads or any other tools (generally and collectively referred to below simply as “tools”) that are removably and replaceably connectable to a 3D printer may be stored in bins of a tool rack for managing tool inventory and interchanging tools during operation of the 3D printer. The local Z positioner 72 is utilized for picking and placing tools in the bins so that the 3D printer can interchangeably use the various modular tools contained in the tool rack. The tool rack may be any suitable combination of containers or other defined spaces for receiving and storing tools.

3D printer 10 also includes controller assembly 38, which may include one or more control circuits (e.g., controller 40) and/or one or more host computers (e.g., computer 42) configured to monitor and operate the components of 3D printer 10. For example, one or more of the control functions performed by controller assembly 38, such as performing move compiler functions, can be implemented in hardware, software, firmware, and the like, or a combination thereof; and may include computer-based hardware, such as data storage devices, processors, memory modules, and the like, which may be external and/or internal to system 10.

Controller assembly 38 may communicate over communication line 44 with print head 24, filament drive mechanisms, chamber 16 (e.g., with a heating unit for chamber 16), head carriage 26, motors for platen gantry 32 and x-y or head gantry 28, motors for local Z positioner 72, and various sensors, calibration devices, display devices, and/or user input devices. In some embodiments, controller assembly 38 may also communicate with one or more of platen assembly 30, platen gantry 32, x-y or head gantry 28, and any other suitable component of 3D printer 10. While illustrated as a single signal line, communication line 44 may include one or more electrical or optical signal lines, and/or wireless connection, which may be external and/or internal to 3D printer 10, allowing controller assembly 38 to communicate with various components of 3D printer 10.

Controller assembly 38 may also direct a retained print head 24 to selectively advance successive segments of the consumable filaments from consumable spools 50 through guide tubes in the umbilicals 57a, 57b, 57c and 57d and into the print heads 24a, 24b, 24c and 24d, respectively. It should be noted that movements commanded by the controller assembly 38 may be directed serially or in parallel. That is, the print heads 24a, 24b, 24c and 24d can be controlled to move along the x, y and z axes by simultaneous directing the x-y gantry 28 and the local Z positioner 72 to re-position the head carriage 26 along each axis. The movement of the print head(s) in the x-y plane can change quickly as the print progresses, potentially requiring having to accommodate the position of the umbilical. The umbilical of the present disclosure limits drag forces and stresses on the print head that would be otherwise caused by unsupported associated wires and tubing to the print head. Reducing drag forces and stresses allows the print head be more responsive and quickly respond change in direction commands from the controller.

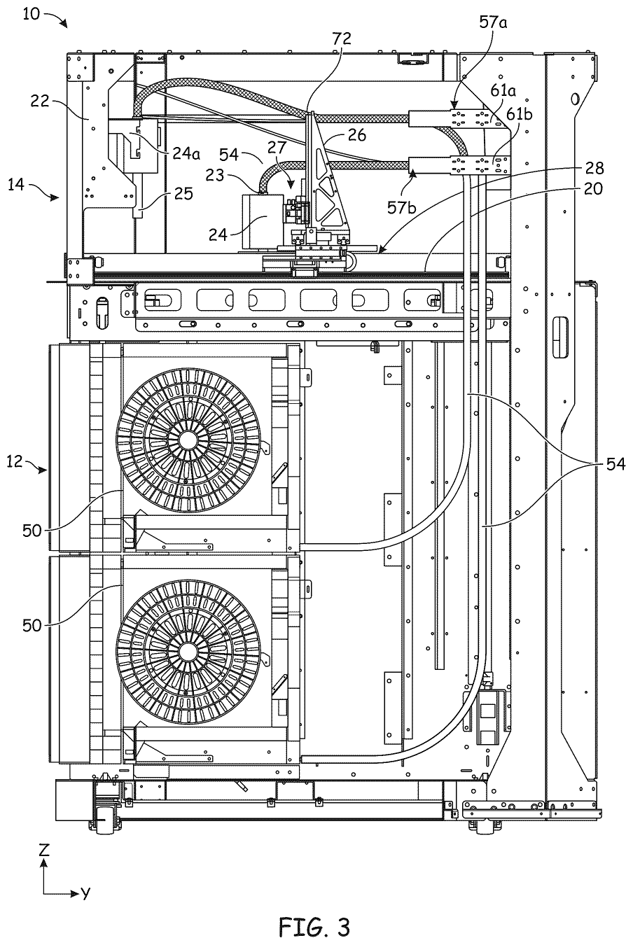

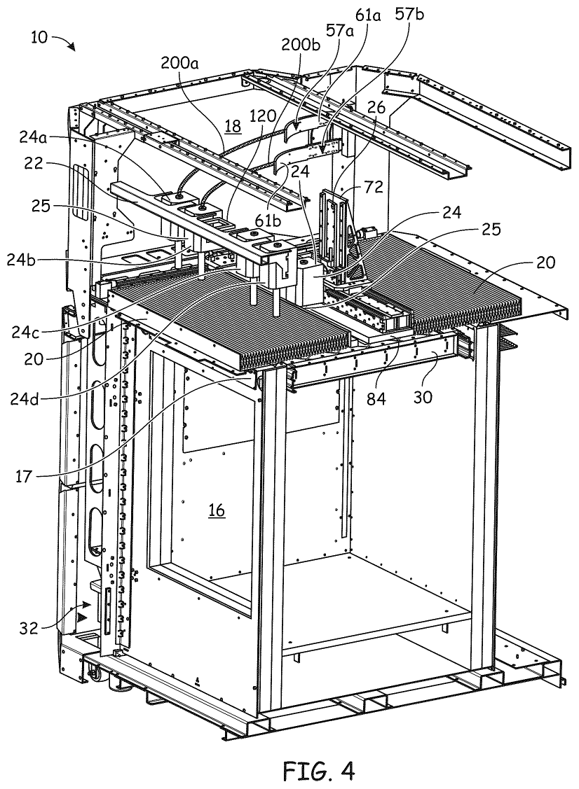

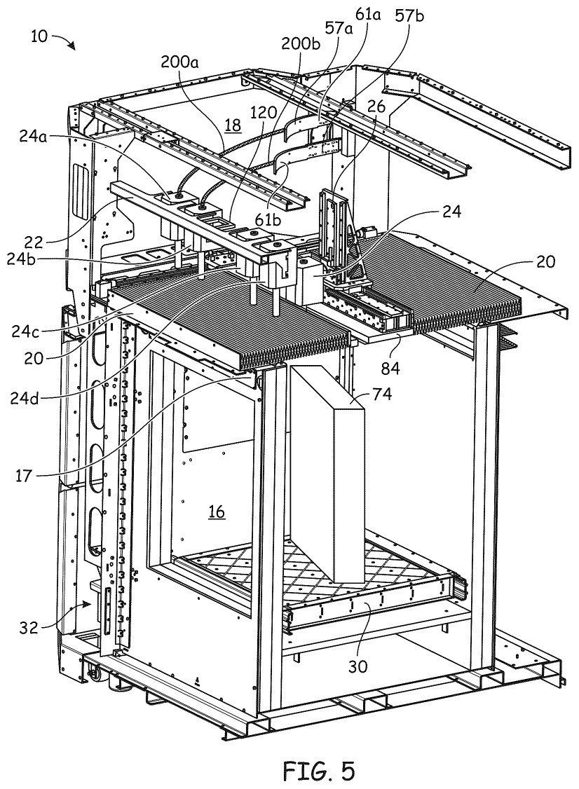

At the start of a build process, the build plane is typically at a top surface of the build platform or platen 30 (or a top surface of a build substrate mounted to the platen) as shown in FIG. 4, where the build platform is positioned to receive an extruded material from the nozzle 25 of the print head. As layers are built, the platen is indexed away from the build plane, allowing printing of a next layer in the build plane. The platen gantry 32, or primary Z positioner, moves the build platform away from the print plane in between the printing of layers of a 3D fabricated part 74 (shown in FIG. 5). One or more parts and associated support structures can be printed in a layer-by-layer manner by incrementally lowering the platen in the z direction. FIG. 5 illustrates portions of 3D printer 10 with the platen 30 at a lowered position, achieved through numerous incremental z direction repositioning steps while printing.

Umbilicals 57a, 57b are located on the left side of the 3D printer (feeding material, controls and power to print heads 24a and 24b) and umbilicals 57c and 57d (feeding material, controls and power to print heads 24c and 24d) are located on the right side of the 3D printer. The structure of the umbilicals 57a and 57b will be described with the understanding that the umbilicals 57c and 57d are mirror images of the umbilicals 57a and 57b.

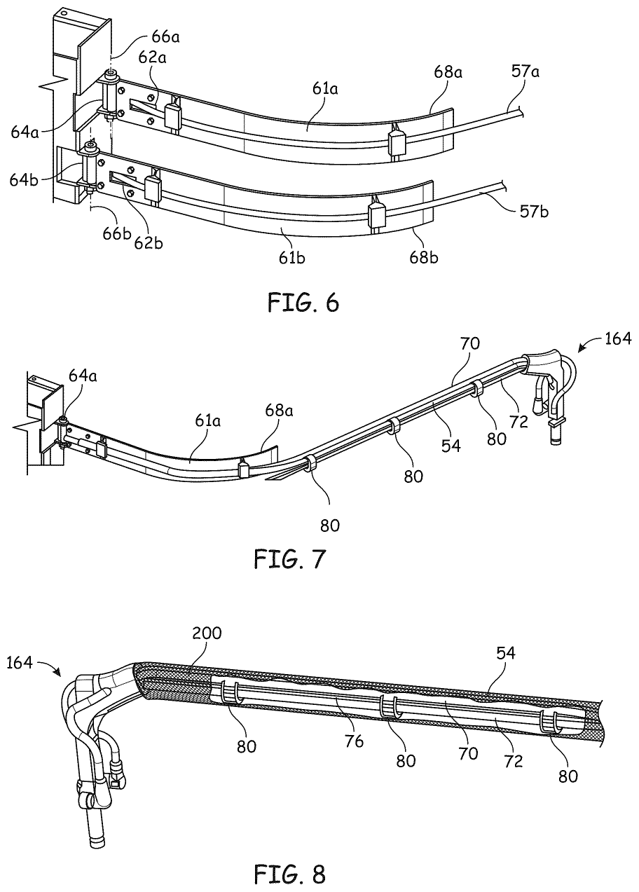

Referring to FIG. 6, the umbilical 57a comprises a substantially rigid pivot arm 61a having a first end 62a pivotally attached to a portion of the printer with a spring-loaded hinge 64a that allows the arm 61a to pivot about a pivot axis 66a while the print head 24a is in use. Once returned to the tool rack, the spring-loaded hinge 64 biases the arm 61a back to the stored position where the umbilical 57a is positioned to move away from the center portion of the tool chamber, as not interfere with the movement of the other print heads 24b, 24c, 24d when in use. The umbilical 57b has the substantially the same configuration as the umbilical 57a, however the spring-loaded hinge 64b is above the spring-loaded hinge 64a and the pivot axis 66b is longitudinally spaced from the pivot axis 66a to provide clearance for each umbilical 66a and 66b from the other umbilical.

Referring to FIGS. 6-8, the umbilical 57a includes the filament tube 54, a power cable 72, a control cable 74 and backbone 76 all of which extend along the length of the umbilical 57a. As shown in FIGS. 7-8, a distal end 162 of the umbilical 57a also includes a flexible, molded guide insert 164 for connecting to the print head 24a. The filament tube 70 is configured to pass filament from a source to the print head 24a while the power cable 70 provides power to the components of the print head 24a and the control cable 72 controls the functions of the components of the print head 24a, such as but not limited to, the filament drive and the heater for the liquefier. The power cable 70 and the control cable 72 are in communication with the controller assembly 38 such that the controller assembly can control the operation of the print head 24a.

The backbone 76 is sufficiently rigid to provide support for the umbilical 57a from the arcuate distal end portion 68a to the print head 24a such that the umbilical 557a does not sag into the path of the other print heads 24b, 24c and 24d and interfere with the operation of the other print heads. The backbone 76 is also sufficiently flexible to allow the print head 24a to move throughout the print envelope while maintaining a minimum bend radius to prevent the filament from fracturing or breaking. The backbone 76 is also resilient to move to a relaxed configuration once the print head is stored on the tool changer, while being relatively light weight to reduce drag on the movement of the print head 24a.

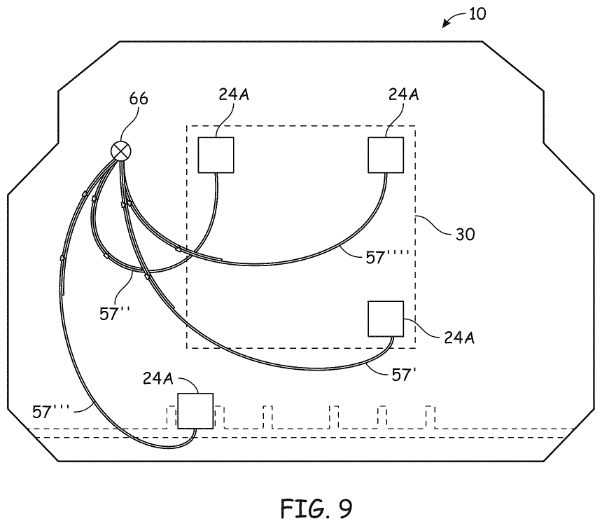

Referring to FIG. 9, a schematic of the flexibility of the umbilical 57 and the backbone that allows the exemplary print head 24a to be moved from the tool rack 22 to a corner of the platen 30 proximate the pivot axis 66. The umbilical 57 and the backbone 76 are in a configuration of minimum curvature at 57′ where the print head 24a is at a location a maximum distance from the pivot 66 and in a configuration of maximum curvature 57″ where the print head is at a location a minimum distance from the pivot 66. The umbilical 57 is at intermediate curvature 57′″ when the print head 24a is located in the tool rack 22 or in another intermediate configuration 57″″ where the print head 24a is located at corner of the platen 30 that is spaced from the pivot 66 and not diagonal from the pivot 66.

The backbone 76 allows the umbilical to travel from the tool rack 22 to substantially over the entire area of the platen 30 while maintaining a minimum bend radius while also retaining the umbilical within the tool chamber 18. Additionally, the backbone 76 prevents the umbilical 57 from sagging and interfering with the operation of other print heads 24 or interfering with the movement of the thermal barrier between the tool chamber 18 and the heated chamber 16.

An exemplary backbone is a 0.098″ nominal diameter carbon fiber rod that can be purchased from Rock West Composites, Inc. located in San Diego, CA. In the disclosed printer, the length of the backbone is about 48 inches. However, the length and diameter of the backbone can change with the size of the printer. Further, other materials of construction and sizes of the backbone are within the scope of the present disclosure as mentioned above provided the material substantially returns to a known configuration after being flexed or bent.

The filament tube 54, a power cable 70, a control cable 72 and backbone 76 are retained in a substantially fixed spatial relationship with respect to each other along the length of the umbilical 57a, with a plurality of spaced apart fixtures 80. The spaced apart fixtures 80 include cavities 83, 84, 86 and 88 to receive and retain the filament tube 54, a power cable 70, a control cable 72 and backbone 76, respectively, such that the filament tube 54, a power cable 70, a control cable 72 and backbone 76.

The filament tube 54, the power cable 70 and the control cable 72 are positioned on opposing sides of the backbone 76 such that the such that the lateral bending is substantially balanced about the backbone 76 such that force required to bend the umbilical to print the part is substantially even in all directions. If the forces required to bend the umbilical including the backbone 76 were unbalanced, then the umbilical could move more easily in one directly and less easily in another direction which could result in printing errors.

In some embodiments, a sleeve 200 is positioned about the filament tube 54, a power cable 70, a control cable 72 and backbone 76 to provide protection to the components. However, the sleeve 200 is optional in the present disclosure.

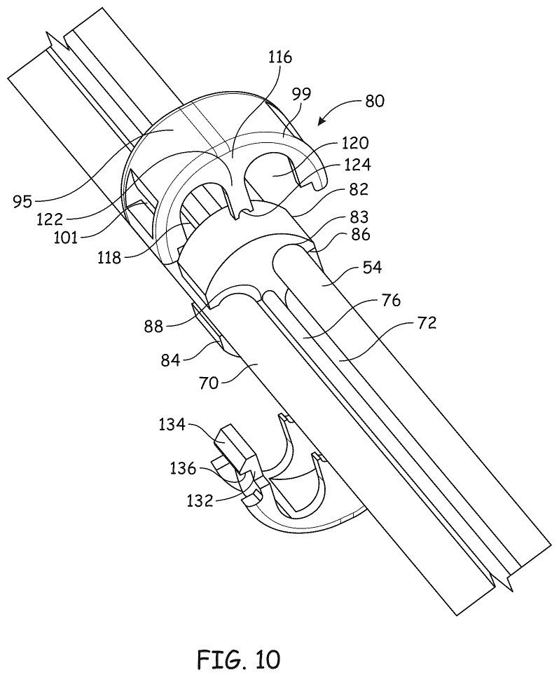

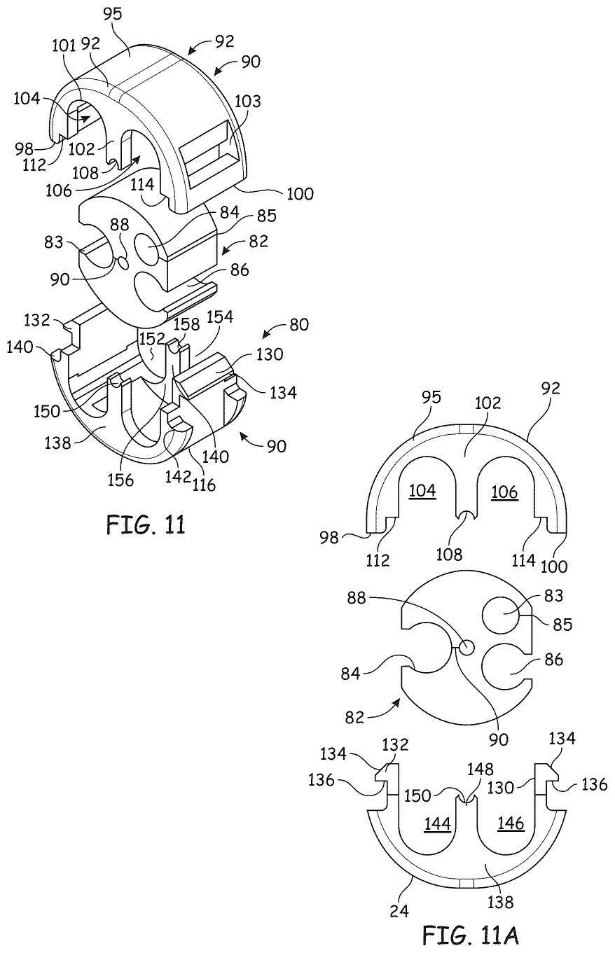

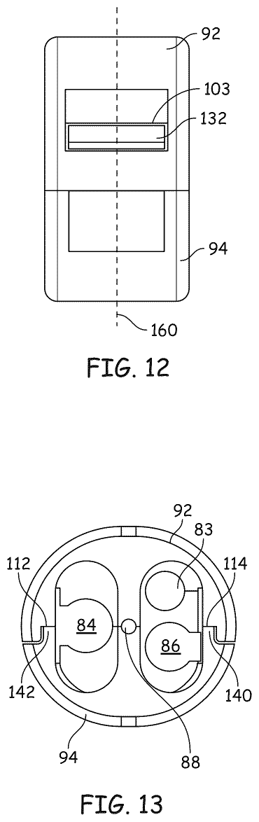

Referring to FIGS. 10-13, each fixture 80 is similarly constructed with an interior portion 82 that is constructed of a sufficiently flexible material to accept and retain the filament tube 54, a power cable 70, a control cable 72 and backbone 76 within the cavities 83, 84, 86 and 88 that is substantially nonconductive and/or non-abrasive. The fixture 80 can be constructed of plastic, rubber or metal, as needed to firmly hold the umbilical items in place. The interior portion 82 includes a slit 90 between the cavity 88 and the cavity 86 such that the backbone 76 can pass through the cavity 86 and the slit 90 and into the cavity 88 where the cavity 88 is spaced from the other cavities 83, 84 and 86. Similarly, the cavity 84 includes a slit 85 that is configured to allow the filament tube to pass through the slit 85 and be retained in the cavity 83.

With the filament tube 54, the power cable 70, the control cable 72 and the backbone 76 retained within the cavities 83, 84, 86 and 88 of the fixture 80, a rigid shell 90 of the fixture 80 is positioned about the interior portion 82 and restricts movement of the filament tube 54, the power cable 70, the control cable 72 and backbone 76. The rigid shell 90 includes an upper portion 92 and a lower portion 94 that are configured to connect together.

The upper portion 92 includes an arcuate middle portion 95 that lead to opposing ends 98 and 100. A front wall 102 extends from a front edge 97 of the middle portion 98 where the front wall 102 includes a left arcuate channel 104 and a right arcuate channel 106 that are separated by a middle projection 108. The middle projection 108 includes an end with an arcuate surface 110 that is configure to be positioned about the backbone 76 that extends beyond the interior portion 82.

A back wall 116 has a similar configuration as the front wall 102 and extends from a back edge 99 of the middle portion 95. The back wall 116 includes left and right arcuate channels 118 and 120 that are separated by a middle projection 122 that has and with an arcuate surface 124 configured to be positioned about the backbone 76 that extends beyond the other side of the interior portion 82.

The lower portion 94 includes an arcuate middle portion 126 that have flexible latches 130 and 132 with similar configurations. The latches 130 and 132 include slanted surfaces 134 that lead to a substantially flat surface 136 that forms a shoulder that are positioned within slots 101 and 103 in the middle portion to retain the upper and lower portions 92 and 94 together. A front wall 138 and the back wall 140 of the lower portion 94 include projections 140 and 142 that mesh with the cut outs 112 and 114 in the front wall 102 and the back wall 116 of the upper portion 92 to aid in retaining the upper portion with the lower portion.

The front wall 138 includes left and right arcuate channels 144 and 146 that are separated by a projection 148 having an end with an arcuate surface 150 configured to be positioned about the backbone 76. The back wall 140 of the bottom portion 94 includes left and right arcuate channels 152 and 154 that are separated by a projection 156 having an end with an arcuate surface 158 configured to be positioned about the backbone 76.

Having symmetry about a midplane 160 of the upper portion 92 and the lower portion 94 allows the shell 90 to be positioned about the interior portion 82 and the filament tube 70, the power cable 72, the control cable 74 and the backbone 76 and be secured together independent of which walls 102 and 116 in the upper portion 92 are aligned with the walls 138 and 140 of the lower portion 94.

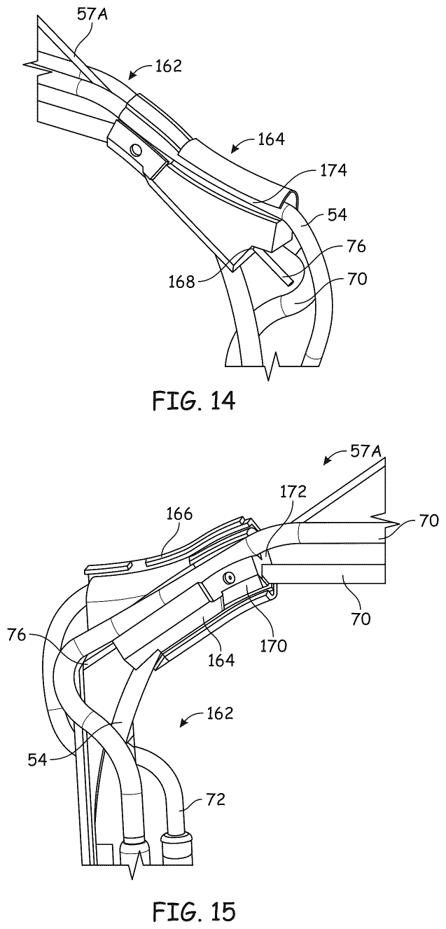

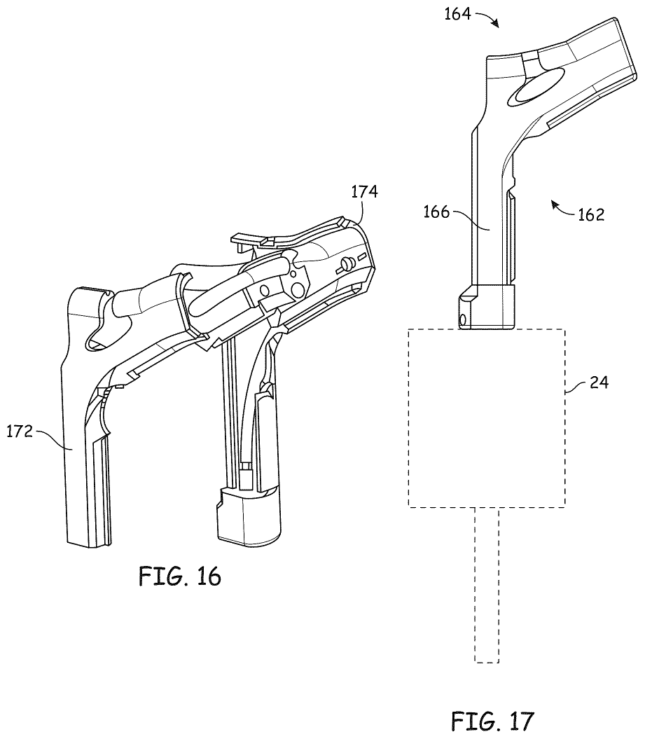

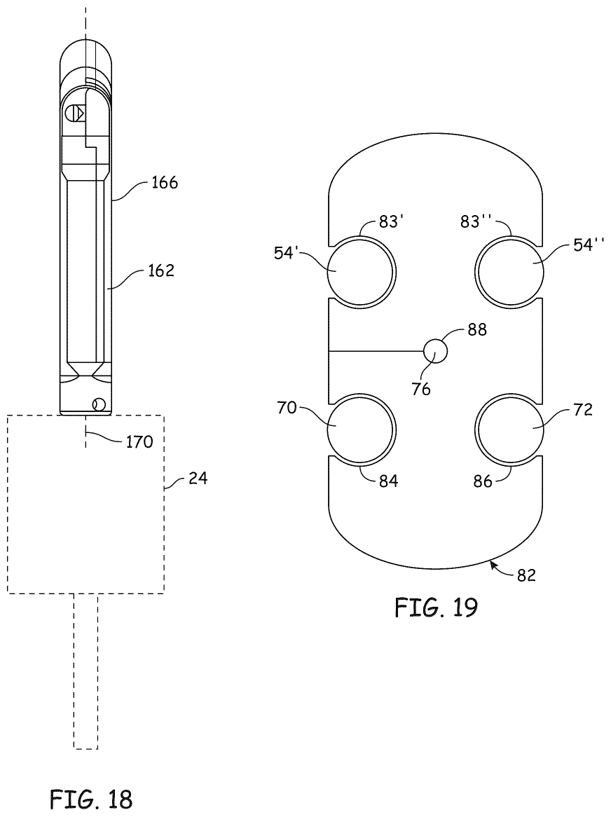

Referring to FIGS. 14-18, a distal end 162 of the umbilical 57a includes a flexible, molded guide insert 164 that is configured to be positioned within a rigid housing 166 pivotally attached to the print head 24a. The guide insert 164 includes a through bore 168 configured to accept the backbone 76, a channel 170 configured to accept the filament tube 54, a channel 172 configured to accept the power cable 70 and a channel 174 configured to accept the control cable 72. Once the filament tube 54, a power cable 70, a control cable 72 and the backbone 76 are secured with in the guide insert 164, the guide insert 164 is then positioned and retained within the rigid housing 168. The filament guide tube 54 is connected to a filament inlet to the print head 24a and the cables 70 and 72w are secured to electrical connectors on the print head 24a. The insert 164 and the rigid housing 168 ensure that the filament does not bend beyond a bend radius proximate the print head, which aids in preventing the filament from fracturing or breaking. Additionally, the distal end 162 pivots about axis 170 relative to the print head 24a as the print head is moved to reduce drag forces. The combination of the umbilical 57a having a pivot axis proximate the pivot axes 66 and 170 proximate the ends aids in reducing drag forces, and preventing wire connections from being twisted or severed, while providing the filament, electricity and control to the print head 24a.

The rigid housing 166 includes interconnecting portions 172 and 174 that define an interior space 176 for the guide insert 164. When the portions 172 and 174 are secured together, the guide insert 164 is secured within the rigid housing 166, while the rigid housing 166 pivots on the axis 170 relative to the print head.

While the umbilicals 57a-57d are disclosed with a single filament tube 54, the umbilical 57a-57d can carry more than one filament tube 54 such that the print head 24 can continue to print after a filament supply is exhausted by starting to feed the second filament. Alternatively, a filament of one material or color can be extracted from the print head and another filament of another material or color can be fed to the print head for continued printing.

Referring to FIG. 19, a sectional view of the insert 82 of the fixture 80 is illustrated where two feed lines 54′ and 54″ are positioned within cavities 83′ and 83″ a substantially equal distance from the backbone 76 located within the cavity 88. Similarly, the power cable 70, the control cable 72 are located in cavities 84 and 86 also a substantially equal distance from the backbone 76. The insert 82 fits within the fixture 80 as disclosed above.

The feed lines 54′ and 54″ have similar resistance to bending and the power cable 70 and the control cable 72 also have similar resistance to bending such that the bending force required to flex the backbone 76 and move the umbilical within the tool chamber is substantially balanced to aid in printing the 3D part.

The line 54″ can be utilized to provide a second filament feed as discussed above. However, the line 54″ can also be utilized to provide additional functionalities to the print head 24 including but not limited to a fiber optic cable for delivering electromagnetic energy proximate the print head or the part being printed from a source remote from the print heat. The electromagnetic energy can be used to heat a portion of the already printed part, such as where a bead is extruded. Alternatively, the source can provide ultraviolet electromagnetic energy which can be used to cure optically sensitive materials that may be used in combination with other materials to print the 3D part.

Alternatively, the line 54″ can be utilized to provide chilled air or pneumatic operating capabilities to the print head. Additional capabilities carried by the line 54″ are also within the scope of the present disclosure.

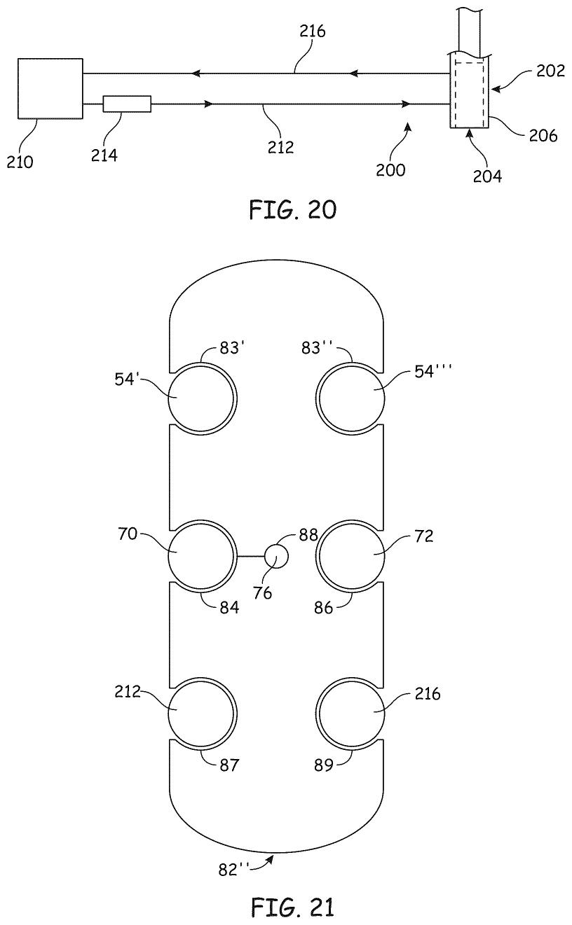

Referring to FIGS. 20 and 21, an alternative print head system for printing with continuous carbon fiber filament, also referred to as prepreg or carbon fiber tape, is illustrated at 200. The system 200 utilizes the umbilicals as previously discussed. However, the alternative print head 202 is configured to process a continuous carbon fiber filament. The continuous carbon fiber filament can require heat requirements that exceed a typical thermoplastic material, which can adversely affect the print head equipment. As such, the alternative liquiefer 204 includes a jacket 206 that provides for active cooling with a cooling fluid, such as water.

The cooling fluid is retained in a reservoir 210 that is spaced from the alternative print heat 202, where the reservoir 210 is typically stationary. A supply line 212 includes a chiller 214 to cool the cooling fluid. The chiller 214 is option where the volume of the reservoir of cooling fluid can maintain the cooling fluid at a desired temperature.

The supply line 212 feeds the cooling fluid into the jacket 206 such that heat is removed along the length of the liquefier tube 202. The heated cooling fluid is returned to the reservoir with a return line 216 to complete the cooling fluid circuit.

To accommodate the supply line 212 and the return line 214, the fixture 82″ includes additional cavities 87 and 89 symmetrically spaced along the midplane of the fixture 82″ to accommodate the additional functionalities for actively cooling the print head 202.

Although the present disclosure may have been described with reference to preferred embodiments, workers skilled in the art will recognize that changes may be made in form and detail without departing from the spirit and scope of the disclosure.

1. An extrusion-based 3D printer configured to print parts in a layer-wise manner, the 3D printer comprising:
a build chamber;
an unheated region above the build chamber;
a print head located in the unheated region, the print head configured to be moved in an x-y plane across the build chamber and also to be lifted and lowered in a z dimension, the print head having a nozzle configured to extend into the build chamber when the print head is lowered; and
an umbilical within the unheated region configured to support a plurality of operational feeds comprising a filament feed tube and a power cable, the umbilical having a length between a first end and a second end, the second end configured to be coupled to the print head, the umbilical comprising:
a backbone running the length of the umbilical, the backbone configured to provide support and flexibility to the plurality of operational feeds; and
a plurality of fixtures spaced along a length of the umbilical, wherein the plurality of fixtures maintains the filament tube, the power cable and the backbone in a spaced apart spatial relationship while providing support from the backbone to the filament tube and the power cable; and
a substantially rigid pivot arm secured to the umbilical proximate the first end, the substantially rigid pivot arm being configured to pivot about a pivot axis as the print head and umbilical move.

2. The extrusion-based 3D printer of claim 1, wherein the plurality of operational feeds further comprises a control cable, wherein the control cable is retained by the plurality of fixtures at a spaced apart spatial relationship relative to the filament feed tube, the power cable and the backbone.

3. The extrusion-based 3D printer of claim 1, wherein the plurality of operational feeds comprises a plurality of filament feed tubes, wherein the plurality of feed tubes is retained by the plurality of fixtures a spaced apart spatial relationship relative to the power cable and the backbone.

4. The extrusion-based 3D printer of claim 1, wherein the plurality of operational feeds further comprises an electromagnetic system configured to direct optical energy proximate the print head.

5. The extrusion-based 3D printer of claim 1, wherein the plurality of operational feeds comprises a cooling system.

6. The extrusion-based 3D printer of claim 5, wherein the cooling system comprises:
a supply line directing cooling fluid toward the print head; and
a return line directing the cooling fluid away from the print head.

7. The extrusion-based 3D printer of claim 1, wherein the plurality of operational feeds comprises a supply of pneumatic gas directed toward the print head.

8. The extrusion-based 3D printer of claim 1, wherein the backbone is configured as a rod and is constructed of a material having a shape memory to return to a predetermined location after being bent while the print head is moving.

9. The extrusion-based 3D printer of claim 8. wherein the material of the backbone comprises carbon fiber, spring steel and/or fiberglass.

10. The extrusion-based 3D printer of claim 8, wherein the backbone prevents filament in the filament feed tube from exceeding a minimum bend radius.

11. The extrusion-based 3D printer of claim 10, wherein the minimum bend radius is about five inches.

12. The extrusion-based 3D printer of claim 1, wherein the unheated region comprises a tool chamber housing a plurality of print heads wherein each of the plurality of print heads is coupled to one a of a plurality of umbilicals within the tool chamber.

13. The extrusion-based 3D printer of claim 1, and further comprising a supply of filament material, wherein a filament path between the supply and the print head is substantially sealed from ambient conditions.

14. The extrusion-based 3D printer of claim 1, wherein the build chamber comprises a heated build chamber, and further comprising a barrier between the build chamber and the unheated region, wherein the print head nozzle extends into the build chamber through the barrier.

15. An extrusion-based 3D printer configured to print 3D parts in a layer-by-layer manner, the 3D printer comprising:
a build chamber;
a build platen within the chamber;
an unheated tool chamber above the build chamber;
a plurality of print heads housed within the tool chamber, each of the plurality of print heads being configured to extrude material onto the build platen or previously extruded material wherein each of the plurality of print heads is configured to be moved in at least an x-y plane across the build chamber and also to be lifted and lowered in a z dimension;
a plurality of filament supplies; and
a plurality of umbilicals having a length between a first end and a second end, each of the plurality of umbilicals being within the tool chamber, each of the plurality of umbilicals is configured to provide a supported path for a plurality of operational feeds comprising a filament feed tube and a power cable, each of the plurality of umbilicals comprises:
a backbone running the length of the umbilical, the backbone configured to provide support and flexibility to the plurality of operational feeds; and
a plurality of fixtures spaced along a length of the umbilical, wherein the plurality of fixtures maintain the filament tube, the power cable and the backbone in a spaced apart spatial relationship while providing support from the backbone to the filament tube and the power cable; and
a substantially rigid pivot arm secured to the umbilical proximate the first end, the substantially rigid pivot arm being configured to pivot about a pivot axis as the print head and umbilical move.

16. The 3D printer of claim 15, wherein each operational feed of each umbilical of the plurality of umbilicals comprises a control cable configured to provide control signals to the print head, wherein the control cable is retained by the plurality of fixtures a spaced apart spatial relationship relative to the filament feed tube, the power cable and the backbone.

17. The extrusion-based 3D printer of claim 15, wherein the plurality of operational feeds comprises a plurality of filament feed tubes, wherein the plurality of feed tubes is retained by the plurality of fixtures a spaced apart spatial relationship relative to the power cable and the backbone.

18. The extrusion-based 3D printer of claim 15, wherein the plurality of operational feeds further comprises an electromagnetic system configured to direct optical energy proximate the print head.

19. The extrusion-based 3D printer of claim 15, wherein the plurality of operational feeds comprises a cooling system.

20. The extrusion-based 3D printer of claim 19, wherein the cooling system comprises:
a supply line directing cooling fluid toward the print head; and
a return line directing the cooling fluid away from the print head.

21. The extrusion-based 3D printer of claim 15, wherein the plurality of operational feeds comprises a supply of pneumatic gas directed toward the print head.

22. The extrusion-based 3D printer of claim 15, wherein the build chamber comprises a heated build chamber, and further comprising a barrier between the build chamber and the unheated region, wherein the print heads each have a nozzle configured to extend into the build chamber through the barrier when the print head is lowered.

23. The extrusion-based 3D printer of claim 15, wherein the backbone is configured as a rod and is constructed of a material having a shape memory to return to a predetermined location after being bent while the print head is moving.

24. The extrusion-based 3D printer of claim 23, wherein the material of the backbone comprises carbon fiber, spring steel and/or fiberglass.

25. The extrusion-based 3D printer of claim 23, wherein the backbone prevents filament in the filament feed tube from exceeding a minimum bend radius.

26. The extrusion-based 3D printer of claim 25, wherein the minimum bend radius is about five inches.

27. The 3D printer of claim 15, wherein each umbilical of the plurality of umbilicals comprises a second pivotal connection proximate the second end of the umbilical.

28. The 3D printer of claim 15, wherein each pivotal attachment of each rigid support arm of the plurality of support arms is biased into the location when the print head is in a standby mode.

29. The 3D printer of claim 15, wherein each of the plurality of fixtures comprises:
a flexible interior portion configured to accept the filament tube, the power cable and the backbone; and
a rigid shell configured to be positioned about the flexible interior portion and retain the retain the filament tube, the power cable, the control cable and the backbone in the spaced apart spatial relationship.

30. The 3D printer of claim 29, wherein the rigid shell of the plurality of brackets comprises:
a first portion; and
a second portion, wherein the first and second portions are configured to be secured together about the flexible interior portion, wherein the first and second portions are symmetrical along a midplane such that the first and second portions are configured to be attached to each other without accounting for orientation of the first and second portions.
